(19) United States
(12) Patent Application Publication
(10) Pub. No.: US 2024/0015041 A1
(43) Pub. Date: Jan. 11, 2024

(54) ATTENDEE STATE TRANSITIONING FOR LARGE-SCALE VIDEO CONFERENCING

(71) Applicant: Vuemix, Inc., San Jose, CA (US)

(72) Inventors: Govind KIZHEPAT, Los Altos Hills, CA (US); Erik NYSTROM, Santa Clara, CA (US)

(73) Assignee: Vuemix, Inc., San Jose, CA (US)

(21) Appl. No.: 17/858,922

(22) Filed: Jul. 6, 2022

(51) Int. Cl. H04L 12/18; H04L 65/403

(52) U.S. Cl. CPC H04L 12/1822; H04L 12/1827; H04L 65/4046

(57) ABSTRACT

The technology disclosed relates to hosting a virtual conference with a plurality of attendees, such that attendees in a first category have an interactive broadcast access to the virtual conference, and attendees in a second category have a view-only broadcast access to the virtual conference. The interactive broadcast access allows the attendees in the first category to share their audio and/or video with the plurality of attendees. The view-only broadcast access allows the attendees in the second category to receive audio and/or video from at least one attendee in the first category, and prevents the attendees in the second category from sharing their audio and/or video with the plurality of attendees. In response to a transition request received from a given attendee in the second category, the given attendee is transitioned from the view-only broadcast access to the interactive broadcast access.

### FIELD OF THE TECHNOLOGY DISCLOSED

The technology disclosed relates to large-scale video conferencing with tens, hundreds, and thousands of attendees. In particular, the technology disclosed relates to dynamically transitioning states of attendees of large-scale video conferences from an invisible, passive state to a visible, active state.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

“Web conferencing” or “virtual conferencing” refers to various forms of online collaborative services including web seminars, webcasts, and peer-level web meetings. Web conferencing systems today support real-time audio and video streaming between participants, typically under the coordination of a central web conferencing server. Applications for web conferencing include online classrooms, meetings, training sessions, lectures, and seminars, to name a few.

Due to the COVID-19 pandemic, video conferencing platforms have transformed from being niche products to being the ubiquitous solution to staying connected both professionally and personally. Large-scale online events with tens, hundreds, and thousands of attendees are live streamed through video conferencing platforms, which in turn have to maintain the boundaries between organizers/panelists/moderators and guest attendees.

The so-called breakout room feature allows a subset of the participants to have a mini-video conference without leaving the original, larger video conference. However, the breakout room feature is not necessarily available to guest attendees.

An opportunity arises to allow attendees of large-scale video conferences to dynamically transition from an invisible, passive state to a visible, active state so as to enhance their interaction and presence. Increased user collaboration and improved user experience may result.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 illustrates a high-level diagram of one implementation of the disclosed video conferencing system that uses a combination of a query server and an audio/video (A/V) server to host large-scale video conferences.

FIG. 2 depicts an example of the disclosed room-centric records used by the query server to maintain meeting states.

FIG. 3 shows different examples of so-called “user kind” categories arranged in a decreasing streaming priority.

FIG. 4 shows an architectural diagram of how the disclosed permissions are derived, in accordance with one implementation of the technology disclosed.

FIG. 5 illustrates different examples of the disclosed permissions.

FIG. 6 shows one implementation of waterfall conditions relating to the disclosed permissions.

FIG. 7 shows another implementation of the waterfall conditions relating to the disclosed permissions.

FIG. 8 depicts how the technology disclosed allows attendees of a meeting to request streams of a target category of users from the A/V server by first issuing representative queries to the query server, which in turn returns an identification of users who fall in the target category.

FIGS. 9A and 9B show logical characterizations of how a passive client initially receiving a streaming broadcast of a meeting transitions into actively interacting with participants of the meeting by visibly entering the meeting, in accordance with one implementation of the technology disclosed.

FIG. 10 portrays one implementation of a client transitioning from a “watching state” to an “audience state” during a video conference by updating the meeting state at the query server.

FIG. 11 illustrates how the disclosed video conferencing system receives, at the query server and the A/V server respectively, metadata and streams from clients attending a video conference.

FIG. 12 is a logical characterization of how the disclosed video conferencing system transitions a view-only attendee of a virtual conference into an interactive attendee.

FIG. 13 is an example method that implements the technology disclosed using a graphical user interface (GUI).

FIG. 14 is a GUI example of an invisible attendee being on the cusp of transitioning into a visible attendee.

FIG. 15 is a GUI example of the invisible attendee having transitioned into the visible attendee.

FIG. 16 is an example computer system that can be used to implement various aspects of the disclosed video conferencing system.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein can be applied to other implementations and applications without departing from the spirit and scope of the technology disclosed. Thus, the technology disclosed is not intended to be limited to the implementations shown but is to be accorded the widest scope consistent with the principles and features disclosed herein.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) can be implemented in a single piece of hardware (e.g., a general purpose signal processor or a block of random access memory, hard disk, or the like) or multiple pieces of hardware. Similarly, the programs can be stand-alone programs, can be incorporated as subroutines in an operating system, can be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### Video Conferencing System

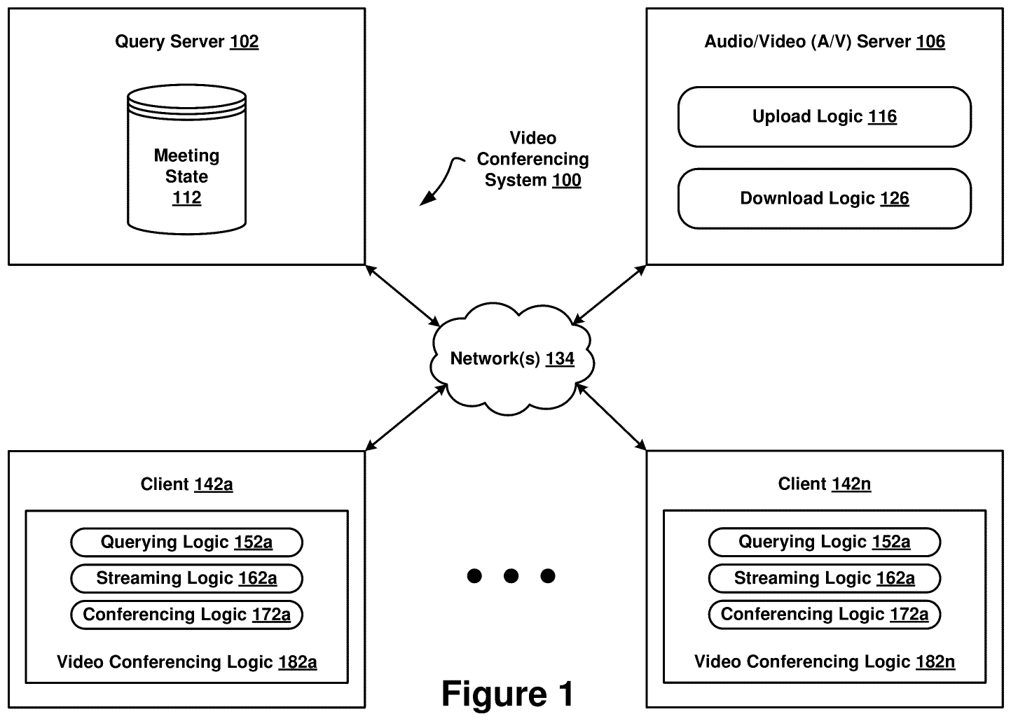

FIG. 1 illustrates a high-level diagram of one implementation of the disclosed video conferencing system 100 that uses a combination of a query server 102 and an audio/video (A/V) server 106 to host large-scale video conferences.

In the illustrated implementation, a plurality of clients 142a-142n connect to the query server 102 and the audio/video (A/V) server 106 over the network(s) 134. The clients 142a-142n can comprise any form of end user devices including desktop/laptop computers (e.g., PCs or Macs), smartphones (e.g., iPhones, Android phones, etc.), tablets (e.g., iPads, Galaxy Tablets, etc.), and/or wearable devices (e.g., smartwatches such as the iWatch or Samsung Gear watch). Of course, the underlying principles of the technology disclosed are not limited to any particular form of user device.

Network(s) 134 couples the clients 142a-142n, the query server 102, and the audio/video server 106 all in communication with each other. The actual communication path can be point-to-point over public and/or private networks. The communications can occur over a variety of networks, e.g., private networks, VPN, MPLS circuits, or Internet, and can use appropriate application programming interfaces (APIs) and data interchange formats, e.g., Web Real-Time Communication (WebRTC), Representational State Transfer (REST), JavaScript Object Notation (JSON), Extensible Markup Language (XML), Simple Object Access Protocol (SOAP), Java Message Service (JMS), and/or Java Platform Module System. All of the communications can be encrypted. The communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G, 5G LTE, Wi-Fi, and WiMAX. Additionally, a variety of authorization and authentication techniques, such as username/password, Open Authorization (OAuth), Kerberos, SecureID, digital certificates, and more, can be used to secure the communications. The engines or system components of FIG. 1 can be implemented by software running on a variety of computing devices. Example devices include a workstation, a server, a computing cluster, a blade server, and a server farm.

In one implementation, each of the clients 142a-142n connect to the query server 102 and the audio/video server 106 through video conferencing logic 182a-182n. The video conferencing logic 182a-182n can be implemented as a browser or conferencing app/application that includes a graphical user interface to allow the end users to interact with the query server 102 and the audio/video server 106 and to participate in a virtual conference using the techniques described herein.

In the illustrated implementation, the video conferencing system 100 includes the query server 102 for persistently storing updates to the state of each virtual conference in a meeting state database 112 (e.g., a key-value noSQL database on AWS Dynamo™). The meeting state 112 tracks the states of the attendees, for example, which participants are visible, audible, etc. In some implementations, the state can be continually updated in response to user input provided via the video conferencing logic 182a-182n running on the various clients 142a-142n. In one implementation, when a new participant joins the conference, the query server 102 provides the client with stored virtual conference state data required to synchronize the new client state with the state of the other clients participating in the conference. The query server 102 can be implemented with a web server. However, the underlying principles of the invention are not limited to this implementation.

In one implementation, after the client's state has been initialized from the meeting state database 112, the query server 102 provides dynamic state updates to the client in accordance with user input from all of the clients 142a-142n during the virtual conference. For example, in one implementation, the query server 102 implements a publish/subscribe mechanism in which each client publishes its own state updates to the query server 102. A client participating in the virtual conference subscribes to the query server 102 to receive the published state updates from all other clients (including itself). Thus, for a virtual conference in which Clients A-D are participants, if Client A publishes a state update (e.g., transitioning from an invisible state to a visible state), the query server 102 can forward the update to all subscribing clients (i.e., Clients A-D), or just to those clients that have subscribed for periodic refresh notifications.

In one implementation, the audio/video server 106 manages the receipt and distribution of audio and video streams for each of the clients 142a-142n. In particular, in one implementation, each client 142a-142n captures audio and/or video of its participant and streams the audio/video to the audio/video server 106, which forwards the audio/video streams to each of the clients 142a-142n. The audio is then decoded and output from speakers and the video is decoded and rendered within each of the conferencing GUIs of the clients 142a-142n.

One implementation of the audio/video server 106 also implements a publish/subscribe mechanism in which each client subscribes to the audio/video streams from every other client. The particular resolution and/or frame rate of each video stream captured on each client can be dependent on the current state of the video conference. For example, when a participant is designated as the current speaker and is provided with the central speaking position within the GUI, that participant's client can capture video having a relatively higher resolution and/or frame rate than when the participant is not the speaker (i.e., and the video of the user is rendered within a small thumbnail region of the GUI).

In one implementation, the audio/video server 106 records audio/video content from the virtual conference and other related data to allow the moderator and/or participants to play back and review the virtual conference at a later time. The video and audio content stored on the audio/video server 106 can be a higher quality than the audio/video used during the live virtual conference. For example, each individual client can capture higher quality video and audio than can be possible to stream through the audio/video server 106. The higher quality audio/video can be stored locally on each individual client 142a-142n during the virtual conference and can be uploaded to the audio/video server 106 following the conference. Additionally, state data and/or other data required to reconstruct the virtual conference for playback can be stored on the audio/video server 106.

The audio/video server 106 comprises an upload/ingest logic 116, which can be implemented as an audio/video ingest server 116. The upload logic 116 controls how the audio and video are transmitted by the clients 142a-142n, i.e., how streams from an end user's camera and mic are sent to other participants to see and hear. The audio/video are captured on the clients 142a-142n and sent to the audio/video ingest server 116, for example, via a dedicated WebSocket/HTTP stream. In some implementations, a dynamically composable, low-bandwidth video is sent on a second WebSocket/HTTP stream, additional details about which can be found in commonly owned U.S. Pat. No. 9,654,789B1, which is incorporated by reference as if fully set forth herein.

For browser applications, a high-resolution video is sent via WebRTC to the audio/video ingest server 116 and includes video encoding on the browser. In some implementations, a fake peer on the audio/video ingest server 116 converts the high-resolution video into a normal video stream. For both native and browser applications, a high-resolution video is multiplexed on the same WebSocket/HTTP stream used by the low-resolution video.

The audio/video are terminated at the audio/video ingest server 116. The audio/video are ingested by the audio/video ingest server 116 regardless of visibility by others. In some implementations, the video delivery is only influenced by the audio/video ingest server 116. That is, challenged clients (e.g., clients with insufficient network capacity, old hardware with limited feature set, etc.) have no influence over the bitrate and other delivery parameters of the sender. In yet other implementations, a configurable duration of the audio/video is buffered on the audio/video ingest server 116, which allows for rewind.

The audio/video server 106 comprises a download/playback logic 126, which can be implemented as an audio/video streaming server 126. The download logic 126 controls how the audio and video are received by the clients 142a-142n, i.e., how an end user sees and hears the meeting. In one implementation, the clients 142a-142n explicitly request arbitrary combinations of audios and videos they wish to see from the audio/video streaming server.

In some implementations of the technology disclosed, there is no inherent sense of a “room,” “meeting,” etc. such that any audio(s)/video(s) combination can be requested from the audio/video streaming server 126. In one implementation, the audio(s) are multiplexed and delivered in a WebSocket/HTTP stream. In another implementation, the video(s) are multiplexed and delivered in a WebSocket/HTTP stream.

In some implementations, the audio/video streaming server 126 handles limited download bandwidth. In one implementation, the clients 142a-142n send beacons to the audio/video streaming server 126 to allow the audio/video streaming server 126 to monitor delay. The audio/video streaming server 126 skips sending video data if delivery is delayed.

The audio/video streaming server 126 can support different types of video streams. One type of video streaming includes multiplexing on the WebSocket. The high-resolution videos are sent as individual video streams and played on the clients 142a-142n using multiple video players, for example, seeing four videos on four video players.

To support very high numbers of visible videos (e.g., 12-1000), the audio/video streaming server 126 can dynamically compose and combine multiple low-latency videos into a single video stream playable on the clients 142a-142n using a single player, additional details about which can be found in commonly owned U.S. Pat. No. 9,654,789B1, which is incorporated by reference as if fully set forth herein. For example, streaming 1, 2, and 4 videos as 1/2/4 high-resolution videos using 1/2/4 separate players versus steaming 8, 12, . . . 100 videos as one video mosaic played using one video player.

The querying logic 152a-152n of the clients 142a-142n allows the clients 142a-142n to request any client's meeting state from the query server 102. In one implementation, the querying logic 152a-152n uses search APIs to query client meeting state from the query server 102. Upon receiving the client meeting state, the clients 142a-142n can use the streaming logic 162a-162n to request any combination of audio(s)/video(s) of any client from the audio/video server 106.

In some implementations, when the clients 142a-142n start sending audio/video to the audio/video ingest server 116, the clients 142a-142n also send metadata to the query server 102. Examples of the metadata include username, room membership(s), categories, tags like mute, raised hand, panelist, moderator, and so on. A client wishing to watch/listen issues a search query to the query server 102, gets the matching results, and then requests the corresponding audio/video from the audio/video streaming server 126. This way, the concept of a room/meeting/stage is purely virtual in the context of the technology disclosed, which allows an end user to send a single set of audio/video yet simultaneously be in five different rooms. For example, an end user can be a panelist in one room, audience in others, hand raised in some, and muted in half.

Also, the technology disclosed obviates the need of explicit coordination between the clients 142a-142n. The clients 142a-142n push their respective state changes to the query server 102. The clients 142a-142n re-query the query server 102 when they want to refresh their results. The clients 142a-142n can also register to receive a subset of global events from the query server 102, for example, notifications when certain users joining, leaving, etc. The clients 142a-142n can use this as an optimization to reduce the refresh frequency.

The conferencing logic 172a-172n allows the clients 142a-142n to use different features of the video conferencing system 100 via GUIs. Examples include entering the room/meeting, signing in, turning audio/video on and off, raising hand, asking questions, chatting, exiting the room, and so on.

### Room-Centric Records

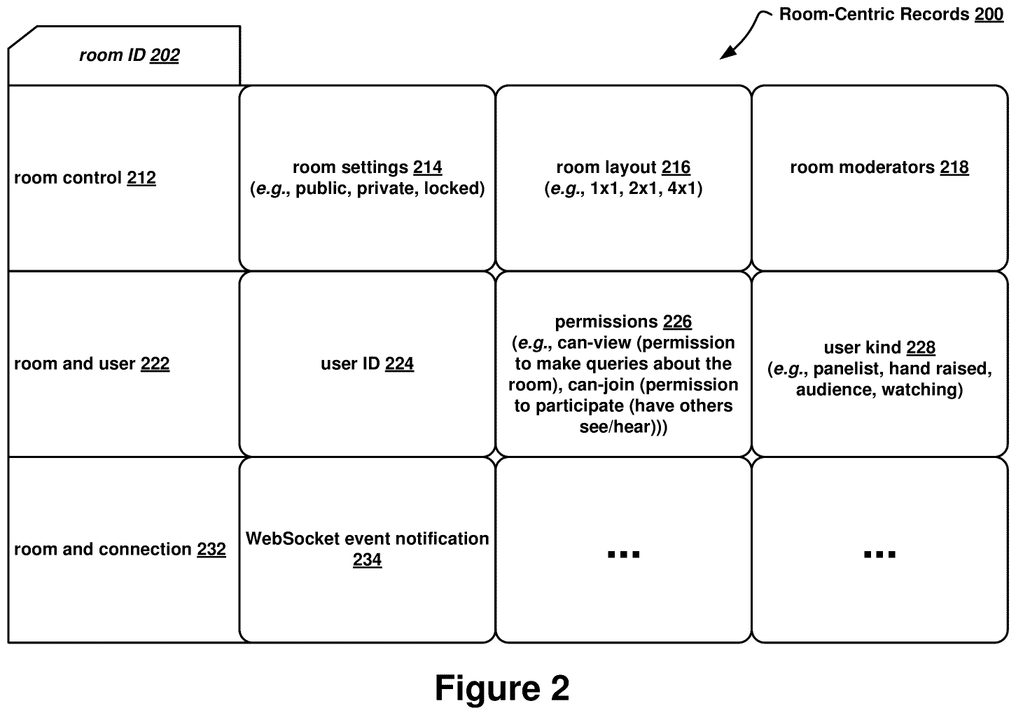

FIG. 2 depicts an example of the disclosed room-centric records 200 used by the query server 102 to maintain room/meeting states. In one implementation, the room-centric records 200 of a room ID 202 include a room control row 212, a room and user row 222, and a room and connection row 232.

The room control row 212 includes the following fields: room settings 214 (e.g., public, private, locked), room layout 216 (e.g., 1×1, 2×1, 4×1), and room moderators 218.

The room and user row 222 includes the following fields: user ID 224, permissions 226 (e.g., can-view (i.e., permission to make queries about the room), can-join (i.e., permission to participate (i.e., have others see/hear))), and user kind 228 (e.g., panelist, hand raised, audience, watching). Here, the primary key is “room” with various indexed fields (e.g., to search via user ID 224, user kind 228).

The room and connection row 232 includes the WebSocket event notification field 234 (i.e., if a client has registered for notifications).

In some implementations, the room control row 212 is a persistent row. In some implementations, the room and user row 222 and the room and connection row 232 are ephemeral and exist only as long as a user is in the room.

In some implementations, the technology disclosed allows multiple connections for the same user. This allows a user to, for example, stream from their Phone (which always has a camera/mic) yet handle the GUI on their desktop to chat, click buttons, raise hands, watch on a larger display, etc. This way, there is one user record for that room and two connection records (one from the phone and one from the desktop), as well as a single A/V ingest stream.

In other implementations, multiple room-centric records for a user are created if the same user is in multiple rooms.

### User Kind

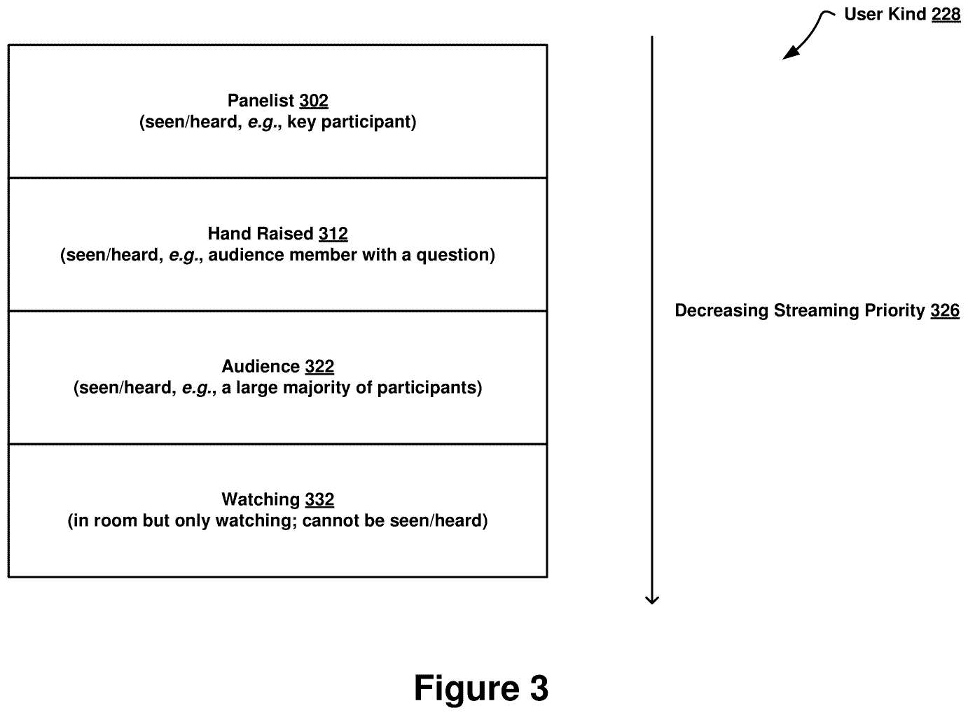

FIG. 3 shows different examples of so-called “user kind” categories 228 arranged in a decreasing streaming priority 326. The panelist participants 302 can see and hear other participants of a room/meeting, and therefore are in the visible/active state. The hand raised participants 312 can be seen and heard by other participants of the room, for example, when the hand raised participants 312 want to ask a question, and therefore are also in the visible/active state. The audience participants 322 can be seen and heard by other participants of the room, and therefore are also in the visible/active state.

In contrast, the watching participants 332 cannot be seen and heard by other participants of the room, but can see and hear the panelist participants 302, the hand raised participants 312, and the audience participants 322. Therefore, the watching participants 332 are in the invisible/inactive state.

### Permissions

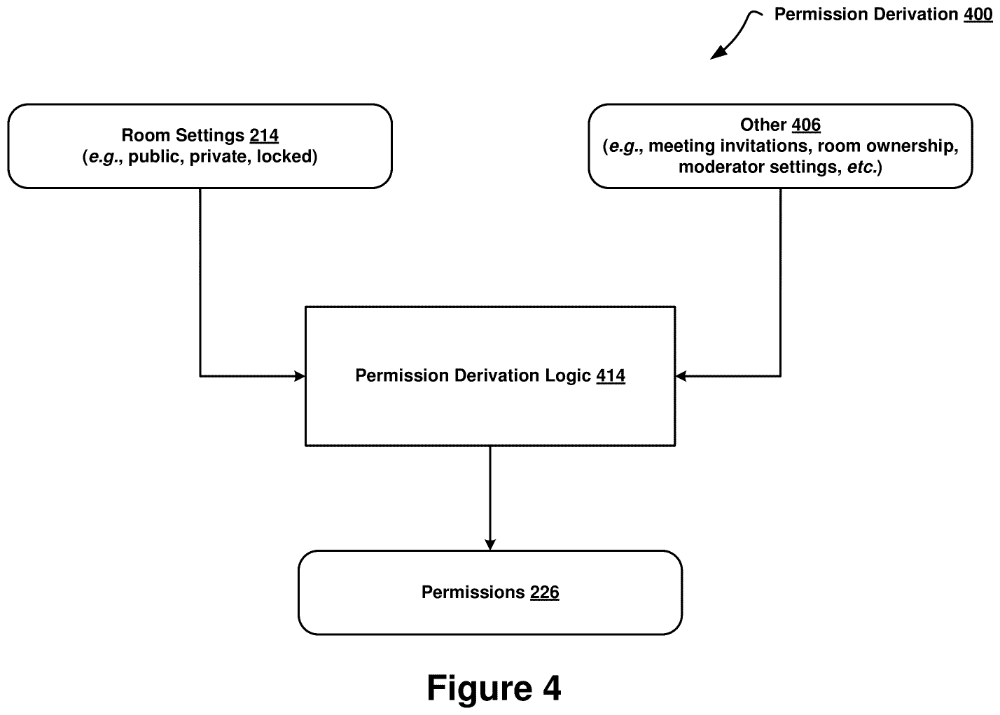

FIG. 4 shows an architectural diagram of how the disclosed permissions are derived 400, in accordance with one implementation of the technology disclosed. In one implementation, a permission derivation logic 414 derives the permissions 226 based on the room settings 214, i.e., whether the room is public, private, locked, etc.

In another implementation, the permission derivation logic 414 derives the permissions 226 based on other factors 406 like whether the user was invited by a room/meeting invitation, whether the user created (owns) the room, the moderator settings of the room, etc. For example, a non-owner/moderator user can be granted permission, aside from being invited, by being explicitly allowed in by an owner or by moderators. The owner or the moderators can see a list of people waiting outside the room and can choose to click a button to let them in.

In yet another implementation, the permission derivation logic 414 derives the permissions 226 based on a combination of the room settings 214 and the other factors 406.

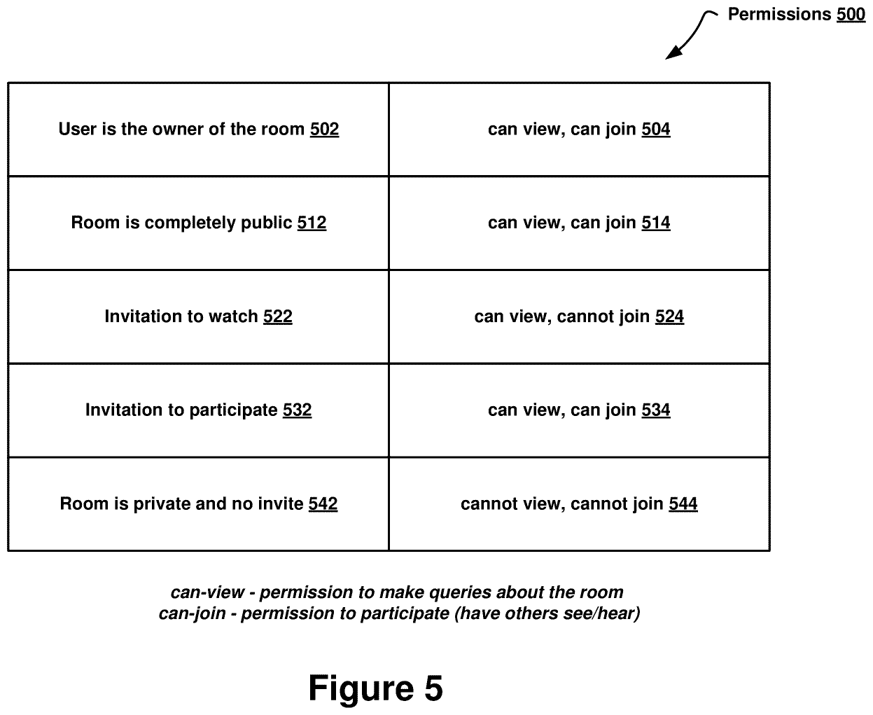

FIG. 5 illustrates different examples of the disclosed permissions 500. In one implementation, an “authenticated user” is a user that registers with the video conferencing system 100 and signs in. In one implementation, a “guest user” is a user that enters the user's email, name, and passes optional captcha; however, there is no verification of the user's name or email. In one implementation, a fully public room is open to both guest users and authenticated users. In one implementation, a public, private, or locked room is open only to authenticated users.

If a user is the owner of the room 502, then the user has “can view, can join” permissions 504. The “can view” permission allows the user to make queries to the query server 102 about the room and for client state data. The “can join” permission allows the user to share the user's audio/video with other participants of the room. Therefore, the “can join” permission configures the user to be in the visible/active state.

If the room is completely public 512, the participants of the room have “can view, can join” permissions 514.

If the user has an invitation to watch the room stream 522, the participants of the room have “can view, cannot join” permissions 524. The “cannot join” permission prevents the user from sharing the user's audio/video with other participants of the room. Therefore, the “cannot join” permission configures the user to be in the invisible/inactive state.

If the user has an invitation to participate in the room 532, the participants of the room have “can view, can join” permissions 534.

If the room is private and the user does not have an invitation to participate in the room 542, the participants of the room have “cannot view, cannot join” permissions 544. The “cannot view” permission prevents the user from making queries to the query server 102.

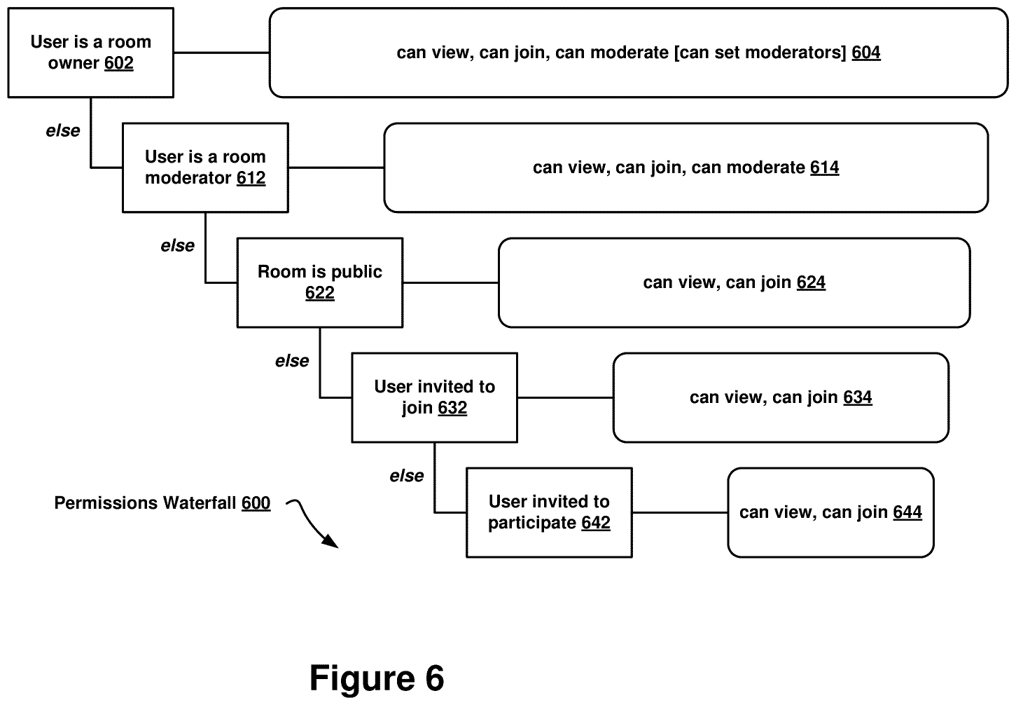

FIG. 6 shows one implementation of waterfall conditions 600 relating to the disclosed permissions. If the user is the room owner 602, the user can view and can join the room meeting 604 and can also set moderates for the room meeting 604. If the user is a room moderator 612, the user can view, can join, and can moderate the room meeting 614. If the room is public 622, the user can view and can join the room meeting 624. If the user is invited to join the room 632, the user can view and can join the room meeting 634. If the user is invited to participate in the room meeting 642, the user can view and can join the room meeting 644.

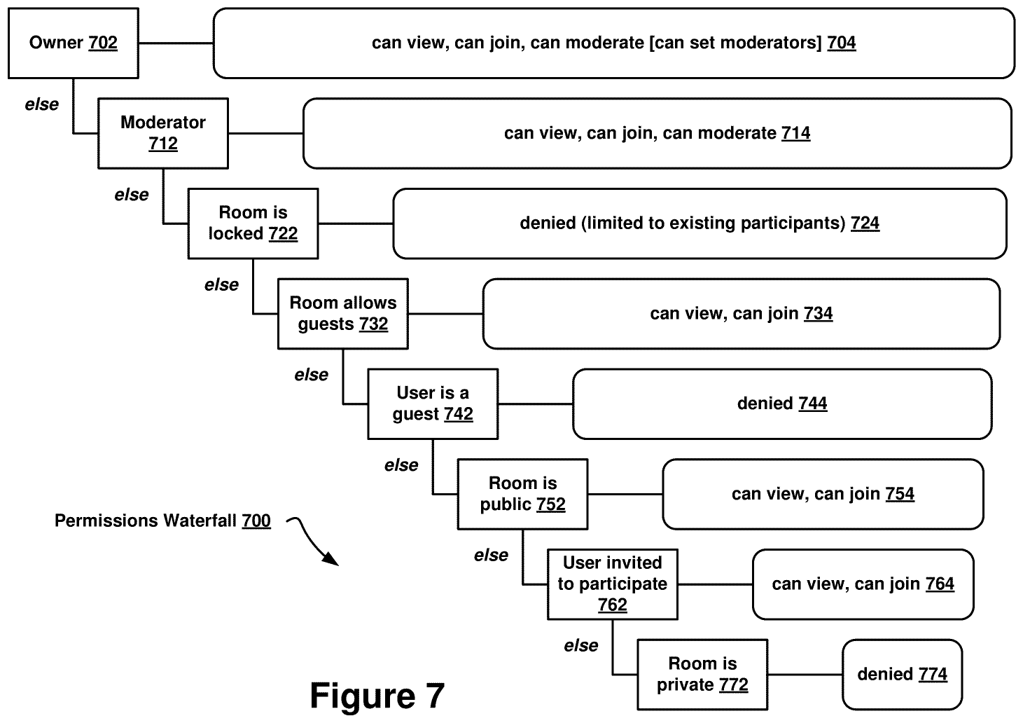

FIG. 7 shows another implementation of the waterfall conditions 700 relating to the disclosed permissions. If the user is the room owner 702, the user can view and can join the room meeting 704 and can also set moderates for the room meeting 704. If the user is a room moderator 712, the user can view, can join, and can moderate the room meeting 714. If the room is locked 722, the user is denied access to the room meeting 724. If room allows entrance of guests 732, the guests can view and can join the room meeting 734. If the user is a guest 742, the user is denied access to the room meeting 744. If the room is public 752, the user can view and can join the room meeting 754. If the user is invited to participate in the room meeting 762, the user can view and can join the room meeting 764. If the room is private 772, the user is denied access to the room meeting 774.

### User Stream Querying

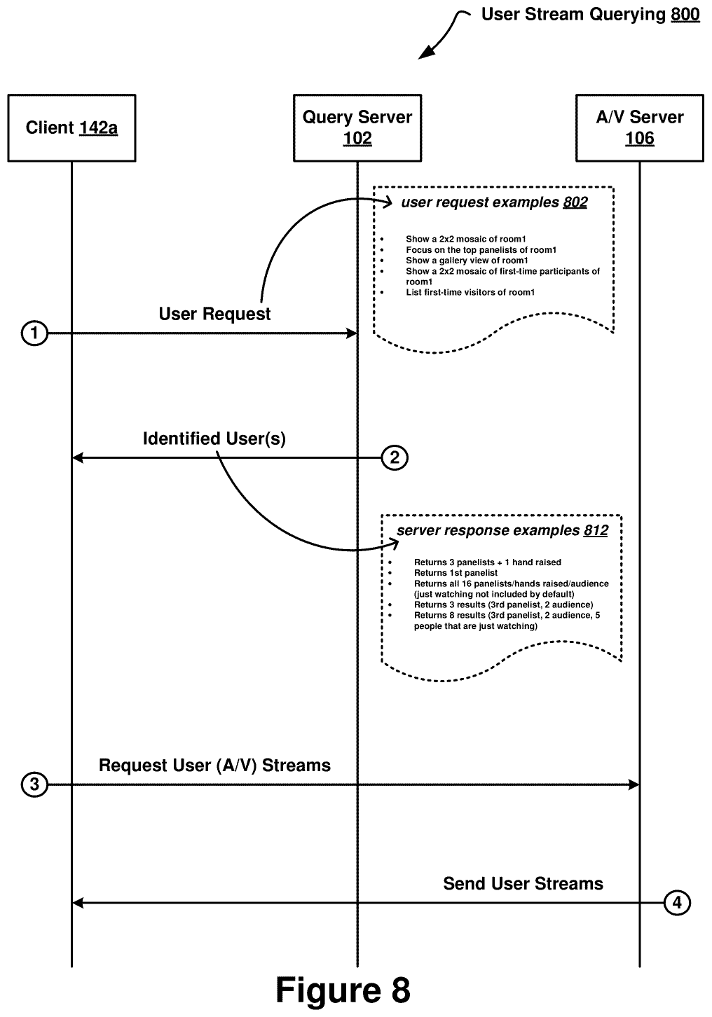

FIG. 8 depicts how the technology disclosed allows attendees of a meeting to request streams of a target category of users from the A/V server 106 by first issuing representative queries to the query server 102, which in turn returns an identification of users who fall in the target category.

At action 1, the client 142a sends a user request to the query server 102. FIG. 8 shows different examples 802 of the user request.

At action 2, the query server 102 returns, to the client 142a, a server response that identifies one or more users that meet the user request. FIG. 8 shows different examples 812 of the server responses.

At action 3, the client 142a requests, from the A/V server 106, the A/V streams of the user(s) identified by the query server 102.

At action 4, the A/V server 106 sends, to the client 142a, the A/V streams of the user(s) identified by the query server 102.

In some implementations, a client request fails if the signed-in user lacks “can view” permission. In some implementations, entries tagged “just watching” are not included in results returned by the query server 102 but, in other implementations, can be included upon request.

Consider the following example. Assume that a meeting room has three panelists, two attendees with hands raised, ten visible/active audience attendees that can be seen and heard by other attendees and can also see and hear other visible/active attendees, and eighteen invisible/inactive attendees just watching other visible/active audience attendees but cannot be seen or heard by other attendees (be it visible/active attendees or invisible/inactive attendees).

In one example, when the client 142a wants to show a 2×2 mosaic of room1, the client 142a sends a user request to the query server 102 requesting identification of members of room1. In some implementations, this user request limits the requested users to four. In response, the query server 102 returns three panelists and one attendee with a hand raised.

In another example, when the client 142a wants to focus on just the top panelist, the client 142a sends a user request to the query server 102 requesting identification of members of room1. In some implementations, this user request limits the requested users to one. In response, the query server 102 returns the first panelist.

In yet another example, when the client 142a wants to show a gallery view of room1, the client 142a sends a user request to the query server 102 requesting identification of members of room1. In some implementations, this user request limits the requested users to sixteen. In response, the query server 102 returns the sixteen panelists/hands raised/audience (just watching not included in some implementations).

In yet another example, when the client 142a wants to show a 2×2 mosaic of first time participants of room1, the client 142a sends a user request to the query server 102 requesting identification of those members of room1 who are on their first room visit, i.e., “room_visits==1.” In some implementations, this user request limits the requested users to four. In response, the query server 102 returns three results, i.e., the third panelist and two audience members.

In yet another example, when the client 142a wants to list all first time visitors of room1, the client 142a sends a user request to the query server 102 requesting identification of those members of room1 who are on their first room visit, i.e., “room_visits==1.” In some implementations, this user request limits the requested users to thirty-two, and includes watching users. In response, the query server 102 returns eight results, i.e., the third panelist, two audience members, and five people who are just watching.

In some implementations, the queries do not have to have any relationship to a normal “meeting.” Each client can, individually, ask anything it wants. One might want to see everyone with the name “Jack,” the next everyone with a birthday date.

### State Transition

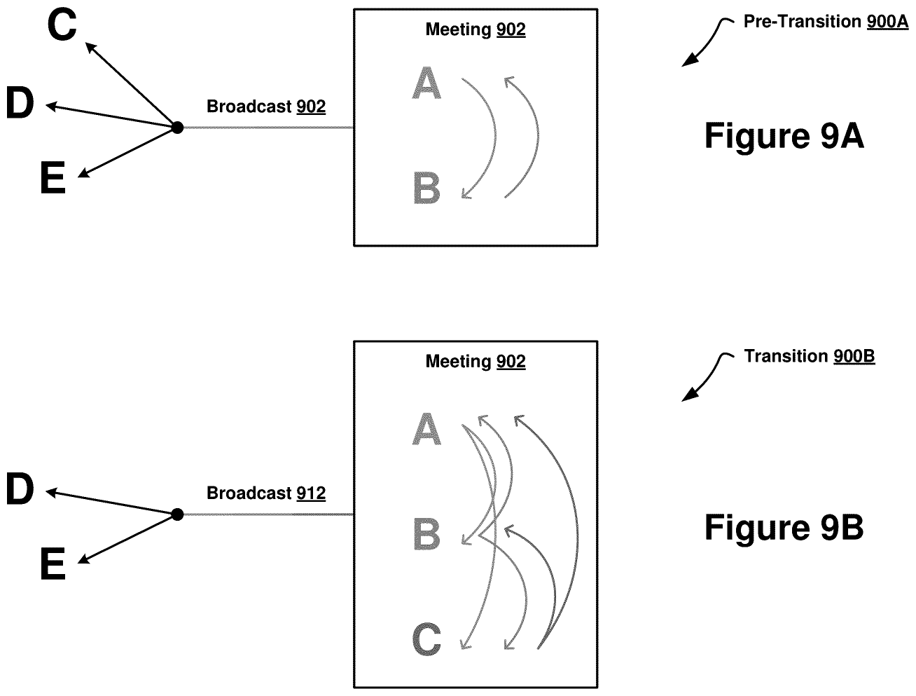

FIGS. 9A and 9B show logical characterizations of how a passive client C initially receiving a streaming broadcast 902 of a meeting 902 transitions into actively interacting with participants A and B of the meeting 902 by visibly entering the meeting 902, in accordance with one implementation of the technology disclosed.

FIG. 9A shows a pre-transition stage 900A at which clients C, D, and E are in an invisible, passive state and are receiving the broadcast 902 from the visible, active participants A and B of the meeting 902. Clients A and B can receive each other's A/V streams but do not receive A/V streams of clients C, D, and E.

FIG. 9B shows a transition stage 900B at which the client C transitions from the invisible, passive state to a visible, active state. As a result, now the clients D and E (still in the invisible, passive state) are receiving the broadcast 912 from the visible, active participants C, A, and B of the meeting 902. Clients C, A, and B can receive each other's A/V streams but do not receive A/V streams of clients D and E.

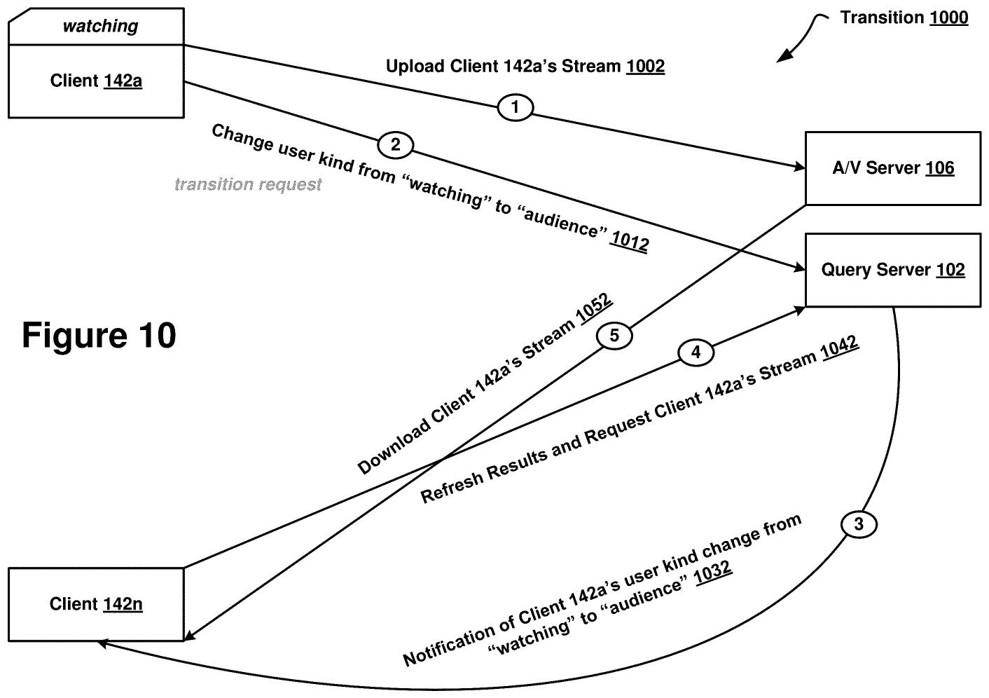

FIG. 10 portrays one implementation of a client transitioning 1000 from a “watching state” to an “audience state” during a video conference by updating the meeting state at the query server.

At action 1, the client 142a (in a watching/invisible/passive state) uploads 1002 its A/V stream to the A/V server 106.

At action 2, the client 142a (still in the watching/invisible/passive state) updates 1012 its state/user kind with the query server 102 from the watching/invisible/passive state to an audience/visible/active state.

At action 3, the client 142n (in an audience/visible/active state) receives a notification from the query server 102 that the client 142a has changed its state/user kind from the watching/invisible/passive state to the audience/visible/active state.

At action 4, the client 142n (in the audience/visible/active state) requests 1042 refreshed results from the query server 102, including requesting client 142a's A/V stream.

At action 5, the client 142n (in the audience/visible/active state) receives the A/V stream of the client 142a (in the audience/visible/active state) from the A/V server 106.

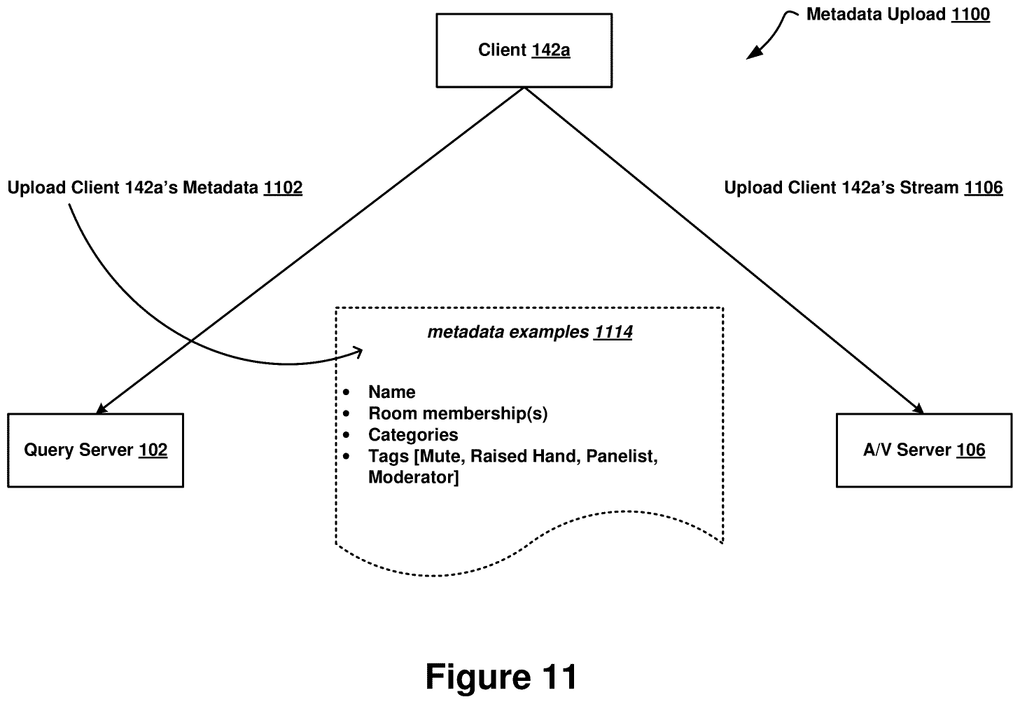

FIG. 11 illustrates how the disclosed video conferencing system 100 receives 1102 and 1106, at the query server 102 and the A/V server 106 respectively, metadata 1100 and streams from clients attending a video conference. FIG. 11 also shows examples 1114 of the metadata, including name, room membership(s), categories, and tags.

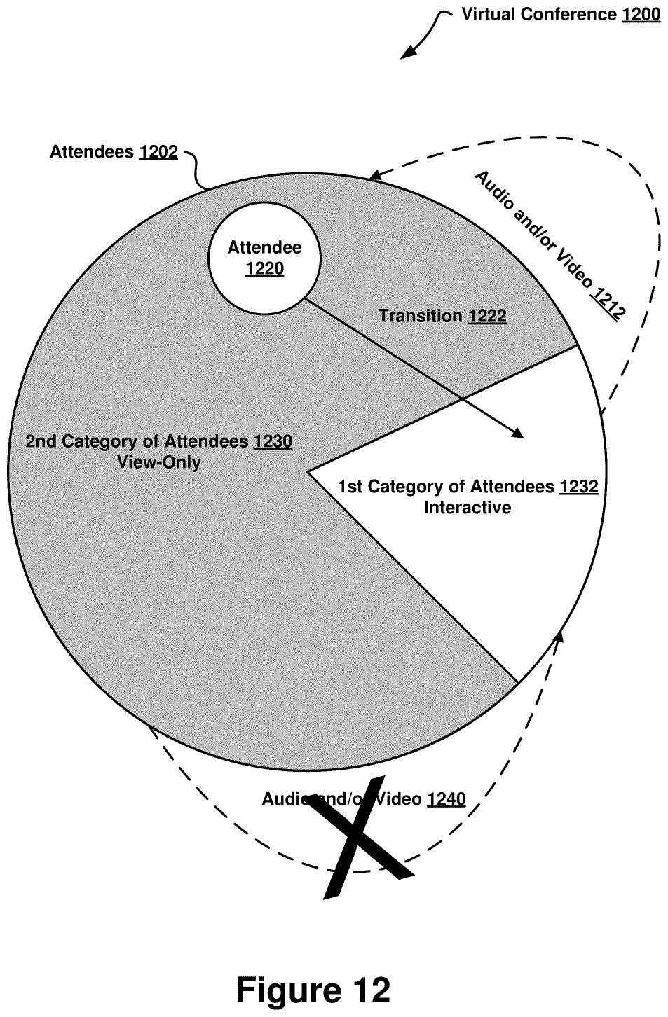

FIG. 12 is a logical characterization of how the disclosed video conferencing system 100 transitions a view-only attendee of a virtual conference 1200 into an interactive attendee.

The virtual conference 1200 has a plurality of attendees 1202, such that attendees in a first category 1232 of attendees in the plurality of attendees 1202 have an interactive broadcast access to the virtual conference 1200, and attendees in a second category 1230 of attendees in the plurality of attendees 1202 have a view-only broadcast access to the virtual conference 1200.

The interactive broadcast access allows the attendees in the first category 1232 of attendees to share 1212 their audio and/or video with the plurality of attendees 1202.

The view-only broadcast access allows the attendees in the second category 1230 of attendees to receive audio and/or video from at least one attendee in the first category 1232 of attendees, and prevents 1240 the attendees in the second category 1230 of attendees from sharing their audio and/or video with the plurality of attendees 1202.

In response to a transition request received from a given attendee 1220 in the second category 1230 of attendees, the given attendee is transitioned 1222 from the view-only broadcast access to the interactive broadcast access.

### GUI Method

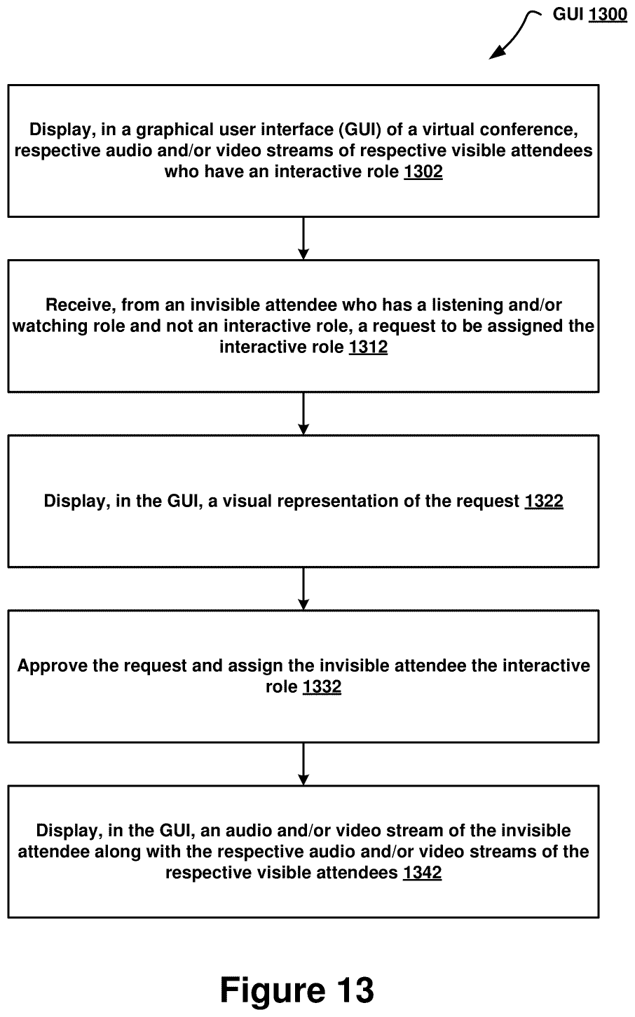

FIG. 13 is an example method 1300 that implements the technology disclosed using a graphical user interface (GUI).

At action 1302, the method includes displaying, in a graphical user interface (GUI) of a virtual conference, respective audio and/or video streams of respective visible attendees who have an interactive role.

At action 1312, the method includes receiving, from an invisible attendee who has a listening and/or watching role and not an interactive role, a request to be assigned the interactive role.

At action 1322, the method includes displaying, in the GUI, a visual representation of the request.

At action 1332, the method includes approving the request and assigning the invisible attendee the interactive role.

At action 1342, the method includes displaying, in the GUI, an audio and/or video stream of the invisible attendee along with the respective audio and/or video streams of the respective visible attendees.

### GUI Examples

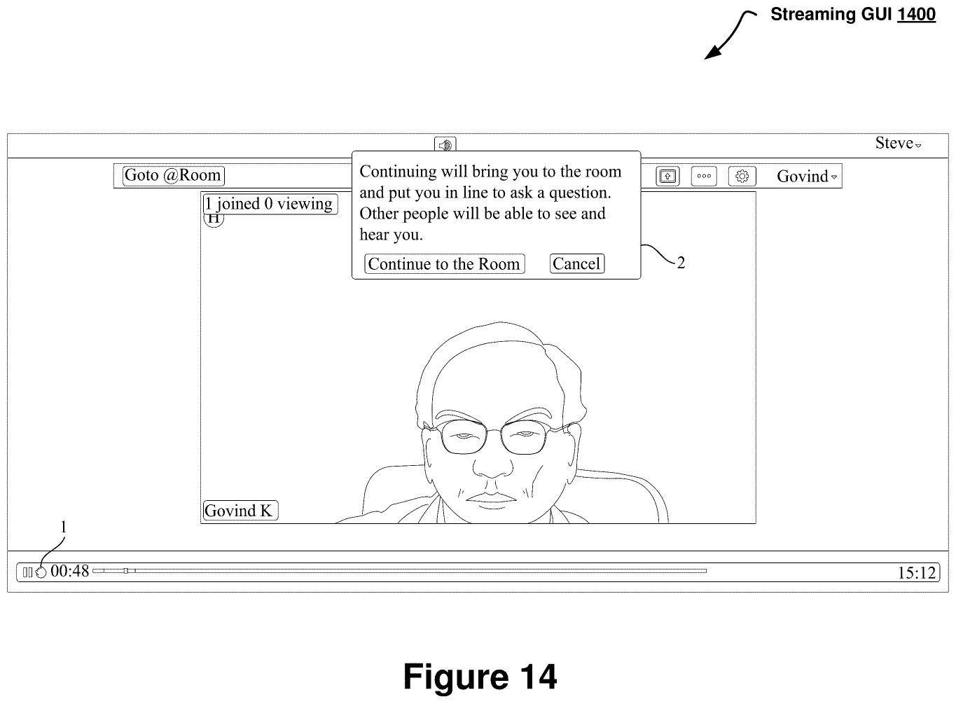

FIG. 14 is a GUI example 1400 of an invisible attendee being on the cusp of transitioning into a visible attendee. The illustrated example shows an invisible attendee named Steve watching the broadcast of a visible attendee named Govind. The legend “1” is next to a hand symbol. Steve clicks the hand symbol when he wishes to transition to active participation, i.e., start being seen and/or heard by Govind. The legend “2” is next to a confirmation pop-up that ensures that Steve understands that he will be transitioning from the invisible, passive state to a visible, active state.

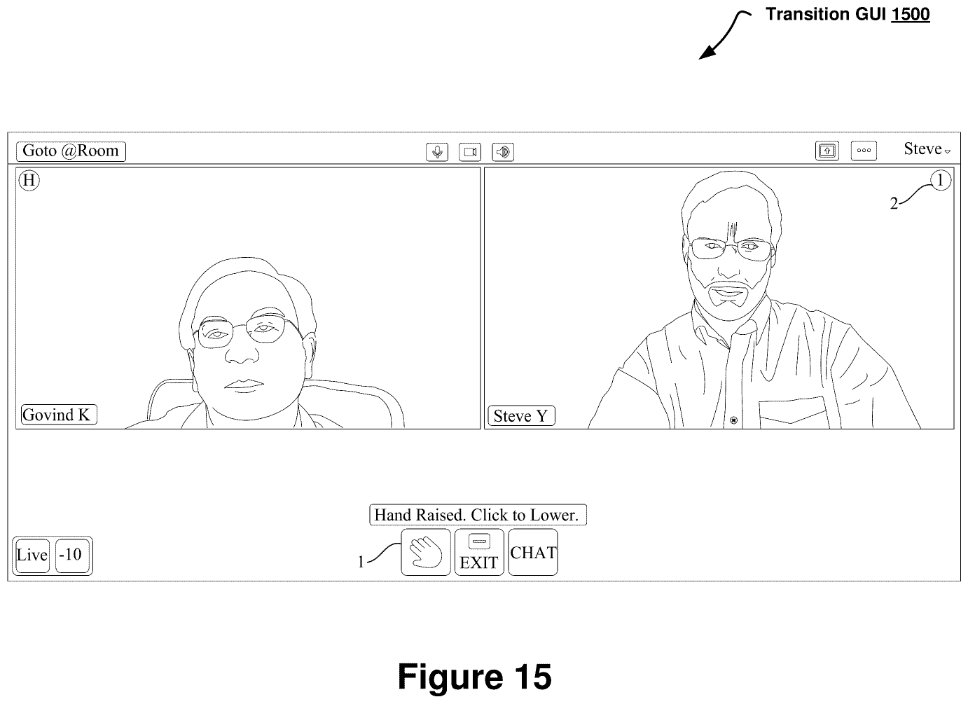

FIG. 15 is a GUI example 1500 of the invisible attendee having transitioned into the visible attendee. FIG. 15 shows Steve's view after he has clicked “Continue to the Room.” In response to the clicking, Steve automatically starts streaming his camera/mic and joins the meeting.

FIG. 15 also shows that Steve raises his hand to ask a question, which is further indicated by the red circle in the top-right, which in turn shows that Steve is the first in line. Also, the red hand button in the bottom-center shows that Steve's hand is raised. The red hand button can be clicked by Steve to both lower his hand and to return to the broadcast-only, invisible, passive state (i.e., FIG. 14).

### Computer System

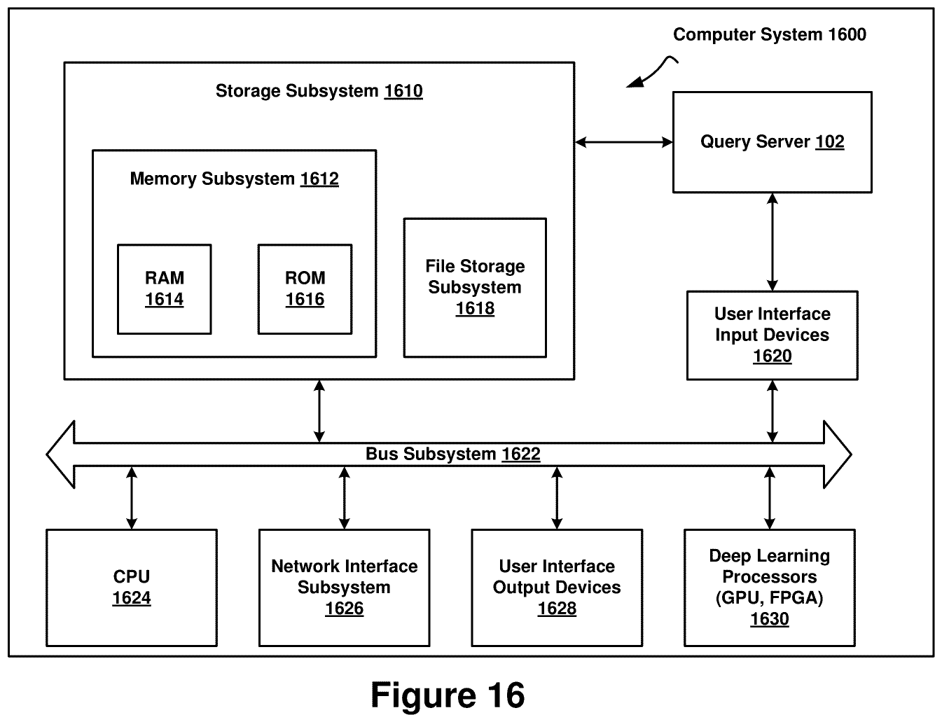

FIG. 16 is an example computer system that can be used to implement various aspects of the disclosed video conferencing system 100. Computer system 1600 includes at least one central processing unit (CPU) 1624 that communicates with a number of peripheral devices via bus subsystem 1622. These peripheral devices can include a storage subsystem 1610 including, for example, memory devices and a file storage subsystem 1618, user interface input devices 1620, user interface output devices 1628, and a network interface subsystem 1626. The input and output devices allow user interaction with computer system 1600. Network interface subsystem 1626 provides an interface to outside networks, including an interface to corresponding interface devices in other computer systems.

In one implementation, the query server 102 is communicably linked to the storage subsystem 1610 and the user interface input devices 1620.

User interface input devices 1620 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1600.

User interface output devices 1628 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1600 to the user or to another machine or computer system.

Storage subsystem 1610 stores programming and data constructs that provide the functionality of some or all of the modules and methods described herein. These software modules are generally executed by processors 1630.

Processors 1630 can be graphics processing units (GPUs), field-programmable gate arrays (FPGAs), application-specific integrated circuits (ASICs), and/or coarse-grained reconfigurable architectures (CGRAs). Processors 1630 can be hosted by a deep learning cloud platform such as Google Cloud Platform™, Xilinx™, and Cirrascale™. Examples of processors 1678 include Google's Tensor Processing Unit (TPU)™, rackmount solutions like GX4 Rackmount Series™, GX16 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1612 used in the storage subsystem 1610 can include a number of memories including a main random access memory (RAM) 1614 for storage of instructions and data during program execution and a read only memory (ROM) 1616 in which fixed instructions are stored. A file storage subsystem 1618 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1618 in the storage subsystem 1610, or in other machines accessible by the processor.

Bus subsystem 1622 provides a mechanism for letting the various components and subsystems of computer system 1600 communicate with each other as intended. Although bus subsystem 1622 is shown schematically as a single bus, alternative implementations of the bus subsystem can use multiple busses.

Computer system 1600 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1600 depicted in FIG. 16 is intended only as a specific example for purposes of illustrating the preferred implementations of the present invention. Many other configurations of computer system 1600 are possible having more or less components than the computer system depicted in FIG. 16.

### Clauses

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed or elements thereof can be implemented in the form of a computer product, including a non-transitory computer-readable storage medium with computer usable program code for performing the method steps indicated. Furthermore, one or more implementations and clauses of the technology disclosed or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer-readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These and other features, aspects, and advantages of the technology disclosed will become apparent from the following detailed description of illustrative implementations thereof, which is to be read in connection with the accompanying drawings. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer-readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

1. A computer-implemented method, including:
hosting a virtual conference with a plurality of attendees, such that attendees in a first category of attendees in the plurality of attendees have an interactive broadcast access to the virtual conference, and attendees in a second category of attendees in the plurality of attendees have a view-only broadcast access to the virtual conference,
wherein the interactive broadcast access allows the attendees in the first category of attendees to share their audio and/or video with the plurality of attendees, and
wherein the view-only broadcast access allows the attendees in the second category of attendees to receive audio and/or video from at least one attendee in the first category of attendees, and prevents the attendees in the second category of attendees from sharing their audio and/or video with the plurality of attendees; and
in response to a transition request received from a given attendee in the second category of attendees, transitioning the given attendee from the view-only broadcast access to the interactive broadcast access.
   2. The computer-implemented method of clause 1, wherein the attendees in the first category of attendees join the virtual conference before an attendee capacity of the virtual conference has been reached.
   3. The computer-implemented method of clause 2, wherein the attendees in the second category of attendees join the virtual conference after the attendee capacity has been reached.
   4. The computer-implemented method of clause 1, wherein the attendees in the first category of attendees are designated the interactive broadcast access when the virtual conference is set up.
   5. The computer-implemented method of clause 1, wherein the attendees in the second category of attendees are designated the view-only broadcast access when the virtual conference is set up.
   6. The computer-implemented method of clause 1, wherein the interactive broadcast access allows the attendees in the first category of attendees to bypass a waiting lobby of the virtual conference.
   7. The computer-implemented method of clause 6, wherein the view-only broadcast access prevents the attendees in the second category of attendees from bypassing the waiting lobby.
   8. The computer-implemented method of clause 1, wherein the view-only broadcast access allows the attendees in the second category of attendees to receive audio and/or video from a selected subset of the first category of attendees, wherein the current speaker belongs to the first category of attendees.
   9. The computer-implemented method of clause 8, wherein the view-only broadcast access prevents the attendees in the second category of attendees from receiving audio and/or video from outside the selected subset of the first category of attendees, wherein the non-current speakers belong to the first category of attendees.
   10. The computer-implemented method of clause 1, wherein the view-only broadcast access allows the attendees in the second category of attendees to receive content shared in the virtual conference by the attendees in the first category of attendees.
   11. The computer-implemented method of clause 10, wherein the content is shared using a share desktop or screen functionality.
   12. The computer-implemented method of clause 1, wherein the view-only broadcast access prevents the attendees in the second category of attendees from participating in a meeting chat in the virtual conference.
   13. The computer-implemented method of clause 12, wherein the view-only broadcast access prevents the attendees in the second category of attendees from seeing the meeting chat.
   14. The computer-implemented method of clause 1, furthering including presenting the transition request to at least one administrator of the virtual conference for evaluation.
   15. The computer-implemented method of clause 14, furthering including transitioning the given attendee from the view-only broadcast access to the interactive broadcast access in response to the administrator approving the transition request.
   16. The computer-implemented method of clause 15, wherein the administrator is an organizer, a host, a panelist, a presenter, and/or a moderator of the virtual conference.
   17. The computer-implemented method of clause 1, furthering including, prior to joining the virtual conference, informing the attendees in the second category of attendees that they will be joining the virtual conference with the view-only broadcast access.
   18. A virtual conferencing system, comprising:
a server or servers configured to host a plurality of attendee clients in a virtual conference, such that
a first set of attendee clients in the plurality of attendee clients is assigned an active state, wherein the active state permits the first set of attendee clients to both transmit and receive audio and/or video during the virtual conference, and
a second set of attendee clients in the plurality of attendee clients is assigned a passive state, wherein the passive state permits the second set of attendee clients to receive the audio and/or video, and not transmit the audio and/or video; and
the server further configured to transition, during the virtual conference, the second set of attendee clients from the passive state to the active state, wherein the active state permits the second set of attendee clients to both transmit and receive the audio and/or video.
   19. The virtual conferencing system of clause 18, wherein the server is further configured to maintain state information about the plurality of attendee clients.
   20. The virtual conferencing system of clause 19, wherein the state information about a given attendee client in the plurality of attendee clients specifies whether the given attendee client is in the active state or the passive state.
   21. The virtual conferencing system of clause 20, wherein the server is further configured to transition the given attendee client from the passive state to the active state in response to approval of a state change request issued by the given attendee client.
   22. The virtual conferencing system of clause 21, wherein the state change request is visually depicted as a raised hand in a graphical user interface (GUI) of the virtual conference.
   23. The virtual conferencing system of clause 21, wherein the state change request is evaluated by at least one administrator attendee client who approves or rejects the state change request.
   24. The virtual conferencing system of clause 23, wherein the administrator attendee client executes a moderator role in the virtual conference.
   25. The virtual conferencing system of clause 23, wherein the administrator attendee client executes a panelist role in the virtual conference.
   26. The virtual conferencing system of clause 18, wherein respective state change requests from respective attendee clients in the second set of attendee clients are queued in a queue.
   27. The virtual conferencing system of clause 26, wherein the respective state change requests are evaluated on a first-in-first-out (FIFO) basis.
   28. A computer-implemented method, including:
displaying, in a graphical user interface (GUI) of a virtual conference, respective audio and/or video streams of respective visible attendees who have an interactive role;
receiving, from an invisible attendee who has a listening and/or watching role and not an interactive role, a request to be assigned the interactive role;
displaying, in the GUI, a visual representation of the request;
approving the request and assigning the invisible attendee the interactive role; and
displaying, in the GUI, an audio and/or video stream of the invisible attendee along with the respective audio and/or video streams of the respective visible attendees.
   29. The computer-implemented method of clause 28, further including receiving, from respective invisible attendees who do not have the interactive role, respective requests to be assigned the interactive role.
   30. The computer-implemented method of clause 29, further including displaying, in the GUI, respective visual representations of the respective requests.
   31. The computer-implemented method of clause 30, wherein the respective visual representations are respective user identifications of the respective invisible attendees.
   32. The computer-implemented method of clause 31, wherein the respective user identifications are respective user icons of the respective invisible attendees.
   33. The computer-implemented method of clause 32, further including displaying, in the GUI, the respective visual representations in a sequence in which the respective requests are received.
   34. The computer-implemented method of clause 33, wherein the respective visual representations graphically display respective ordinal positions of the respective requests in the sequence.
   35. The computer-implemented method of clause 34, further including, in response to approval of a given request in the respective requests, removing the given request from the sequence.
   36. The computer-implemented method of clause 35, further including graphically displaying the removal.
   37. The computer-implemented method of clause 36, further including graphically displaying the removal by disappearing from the sequence a given user icon of a given invisible attendee that issued the given request.

What is claimed is:

1. A computer-implemented method, including:
a meeting state query server tracking a state of a plurality of attendees of a virtual conference, and a meeting audio/video server distributing audio/video streams of some of the plurality of attendees amongst the plurality of attendees;
the meeting state query server having a first attendee in the plurality of attendees in an audience state, and having a second attendee in the plurality of attendees in a watching state, wherein the audience state prevents the meeting audio/video server from sharing the first attendee's audio/video stream with the second attendee, and wherein the watching state allows the meeting audio/video server to share the second attendee's audio/video stream with the first attendee; and
the meeting state query server transitioning the first attendee from the audience state to the watching state, and notifying the second attendee of the transition, wherein the transition allows the meeting audio/video server to share the first attendee's audio/video stream with the second attendee.

2. The computer-implemented method of claim 1, wherein a particular one of the plurality of attendees is tracked in the meeting state query server so as to simultaneously have a hand raised virtual conference state in a first one of a plurality of rooms in which they are simultaneously included while the same time not having a hand raised virtual conference state in a second one of the plurality of rooms in which they are simultaneously included.

3. The computer-implemented method of claim 2, wherein a particular one of the plurality of attendees is tracked in the meeting state query server so as to simultaneously have an interactive broadcast access virtual conference state in a first one of the plurality of rooms in which they are simultaneously included while the same time having a view only broadcast access virtual conference state in a second one of the plurality of rooms in which they are simultaneously included.

4. The computer-implemented method of claim 2, wherein a particular one of the plurality of attendees is tracked in the meeting state query server so as to simultaneously have a virtual conference state assigned when the virtual conference is set up and a virtual conference state selected by the particular one of the plurality of attendees after the virtual conference has started.

5. (canceled)

6. The computer-implemented method of claim 2, wherein a particular one of the plurality of attendees is tracked in the meeting state query server so as to simultaneously have a muted virtual conference state in a first one of the plurality of rooms in which they are simultaneously included while the same time having a non-muted virtual conference state in a second one of the plurality of rooms in which they are simultaneously included.

7. The computer-implemented method of claim 2, wherein a particular one of the plurality of attendees is tracked in the meeting state query server so as to simultaneously have a video broadcast included virtual conference state in a first one of the plurality of rooms in which they are simultaneously included while the same time having a video broadcast not included virtual conference state in a second one of the plurality of rooms in which they are simultaneously included.

8-9. (canceled)

10. The computer-implemented method of claim 1, wherein a plurality of room-centric records is tracked in the meeting state query server.

11. The computer-implemented method of claim 10, the meeting state query server further tracking a room-specific hand raise virtual conference state of the plurality of attendees.

12. The computer-implemented method of claim 10, the meeting state query server further tracking a room-specific muted virtual conference state of the plurality of attendees.

13. The computer-implemented method of claim 10, the meeting state query server further tracking a room-specific view-only virtual conference state.

14-20. (canceled)
